(19) United States
(12) Patent Application Publication
(10) Pub. No.: US 2010/0050314 A1
(43) Pub. Date: Mar. 4, 2010

(54) Healthcare Garments and Linens that have Suggestive Prompts on them such as "Clean your Hands"

(76) Inventors: Michael Joseph Oleyar, Flushing, MI (US); Meredith Lindsay Price, Eastpointe, MI (US)

Correspondence Address: Michael J. Oleyar, 404 Virginia Apartment 6, Royal Oak, MI, 48067, US

(21) Appl. No.: 12/198,118

(22) Filed: Aug. 26, 2008

(51) Int. Cl. A41D 10/00; A41D 13/12; A47G 9/02; A47G 9/00; G09F 21/02

(52) U.S. Cl. 2/83; 2/114; 5/495; 5/482; 40/586

(57) ABSTRACT

The present invention relates to placement of visual prompts on hospital garments and linens to suggest workers to practice hand hygiene. Prompts will be text in any language, symbols, or other designs and will be affixed to garments and linens with stickers, buttons, embroidery, dye, paint, and other means. Specifically the invention includes designs and/or statements including but not limited to CLEAN YOUR HANDS and PLEASE WASH YOUR HANDS FIRST on hospital linens and hospital garments, such as patient gowns, scrubs, sheets, and blankets to prompt healthcare workers in contact with patients to wash their hands.

### CROSS REFERENCE TO RELATED APPLICATIONS

Some individuals have tried unique approaches to the problem of inadequate hand hygiene including patents like the patent to Johnson, U.S. Pat. No. 6,038,331, which is an apparatus and method for monitoring hand hygiene designed to increase the quality of hand hygiene, and the patent to Harper et al., U.S. Pat. No. 7,293,645, which includes providing individuals with hand sanitizer and uses a unique method for monitoring use. Despite the existence of these patents for some time, the inventions described are not used in mainstream healthcare and their efficacy of improving the quantity or quality of hand hygiene has not been demonstrated. Therefore, unique solutions to the global problem of poor hand hygiene are still needed.

### BACKGROUND OF THE INVENTION

Healthcare workers are constantly encountering patients, caring for them and performing procedures with their hands. Due to the extreme volume of patients in hospital systems, time constraints in which healthcare workers must perform their duties, and stress, healthcare workers often neglect to comply with recommended protocols concerning hand hygiene. Studies have shown that hands of healthcare workers contain numerous microflora including multiple variants of staphylococcus and that microflora on hands may serve as a source of contamination by direct contact and transfer of microflora from patient to patient. Contaminated hands lead to increased infection rates, morbidity, mortality, and greater healthcare costs. The effectiveness of hand hygiene in reducing the transfer of microorganisms from healthcare workers to patients has been well documented. Unfortunately, compliance with hand hygiene protocols has been shown to be low in various departments at hospitals around the world—whether it is low in quantity, quality, or both. Published studies have investigated the level of hand hygiene in areas of the hospital including intensive care units, emergency departments, and internal medicine wards, and the studies have all shown low compliance with recommendations for hand hygiene from the Centers for Disease Control and Prevention (CDC).

Many reasons for poor hand hygiene are cited although still lacking is a solution to the problem. Much time has been spent trying to determine the best methods for increasing hand hygiene among healthcare workers, and some attempts at interventions to increase hand hygiene compliance have been initiated by experts. Despite some great efforts by infectious disease specialists around the world, no clear solution to the problem of poor hand hygiene in healthcare exists. Single-modal interventions including increasing hand hygiene supplies, educating workers, and placing signs reminding workers to wash their hands have shown to increase hand hygiene short term but to levels that is still considered unacceptable. Moreover, studies fail to show the long term efficacy of these types of interventions. Multi-modal interventions have produced better results, but many institutions still fall short of their hand hygiene goals. Many of the experts suggest new approaches may be necessary to increase hand hygiene.

The invention described in this patent addresses the problem of low compliance with hand hygiene by simply placing a reminder for healthcare workers to wash their hands on linens and garments used in health care. It is an effective, inexpensive way to institute a multi-modal intervention by reminding workers to properly clean their hands and involving patients in discussion with health care providers about hand hygiene.

### BRIEF SUMMARY OF THE INVENTION

Object: provide a simple, cost-effective means for increasing hand hygiene.

The present invention encompasses placing visual cues on items including but not limited to patient gowns, scrubs, uniforms, surgical drapes, various coats, blankets, sheets, and pillowcases in healthcare settings with the purpose of improving hand hygiene compliance according to CDC recommendations. The invention includes placement of text, symbols or other designs on patient gowns etc., so that the visual prompts may be seen by a person from the bedside. Specifically, prompts including but not limited to “CLEAN YOUR HANDS” and “PLEASE WASH YOUR HANDS FIRST” will be affixed to gowns etc. with stickers, buttons, embroidery, dye, paint, and/or other means.

One advantage to the invention is that it may be used with practically any gown design. The description of this invention will delineate its use with the typical patient gown, although the design may be easily adapted to fit many other gown designs including some of the newer designs mentioned in the background section. Typical gown design usually includes construction of cotton and/or polyester. Usually it consists of a single piece of fabric with clasping mechanisms such as metal snaps, Velcro, ties, or buttons to close the neck and/or back of the garment while the patient is wearing it.

Labeling hospital garments with “Clean your hands” or “Wash your hands first” serves the purpose of reminding healthcare providers of the importance of hand hygiene in regards to patient care. The invention also includes the phrase placement on other linens used in the hospital such as blankets, sheets, and pillowcases as well as garments worn in the hospital including scrubs, jackets, gowns, scrub hats, socks, and others. The invention also encompasses phrase placement on any part of hospital linens and garments including the thorax, sleeves, abdomen, legs, feet, etc. This invention will conveniently place a reminder for healthcare providers, which should be visible from a few feet away from the patient. A primary design includes the placement of text on patient gowns because gowns are worn by all patients and can be easily seen by healthcare workers.

### DETAILED DESCRIPTION OF THE INVENTION

The present invention relates to utilizing hospital garments and linens in the healthcare setting to improve hand hygiene among healthcare workers and reduce the transmission of bacteria and other microflora to patients by providing a well placed visual cue reminding individuals in contact with the patient to wash their hands. Specifically, the invention includes visual prompts on patient gowns and other garments and linens including but not limited to scrubs, uniforms, surgical drapes, various coats, blankets, sheets, and pillowcases to remind workers to clean their hands. It is the idea of the authors that this patent will provide a solution to the problem by placing prompts promoting hand hygiene in the best location possible—on the patient's garment or in a close proximity to the patient on other garments and linens. While it may be easy for healthcare workers to dismiss signs reminding them to wash their hands, it is believed that a prompt placed on the patient's gown or on the hospital linens within the proximity of the patient will be more difficult to dismiss.

The final reminder for healthcare workers that have forgotten to wash their hands prior to examining or performing a procedure on a patient will be a suggestive visual prompt from the patient's garment and/or linen. Most importantly, placing prompts on hospital garments and linens reminds the patient and the patient's family that hand hygiene by healthcare providers is essential. All prior patented interventions concerning hand hygiene have targeted the healthcare provider only. This invention is unique in that it is the first of its kind to promote a dialogue between healthcare provider and patient concerning hand hygiene compliance. This invention is a novel way of prompting healthcare workers to take action and encourages patients to get involved in their own care, which leads to improved patient health and lower healthcare costs.

The present invention relates to placement of visual prompts on hospital garments and linens to suggest workers to practice hand hygiene. Prompts will be text, symbols, or other designs and will be affixed to garments and linens with stickers, buttons, embroidery, dye, paint, and other means. Specifically the invention includes designs and/or statements including but not limited to CLEAN YOUR HANDS, PLEASE WASH YOUR HANDS FIRST, and ASK ME TO WASH MY HANDS on hospital linens and hospital garments, such as patient gowns, scrubs, sheets, and blankets to prompt healthcare workers in contact with patients to wash their hands, and prompt patients to request and even demand adequate hand hygiene.

While the invention includes prompts placed on garments and linens in the proximity of the patient visible by the patient and nearby healthcare worker, it is the opinion of the authors that prompts will be most effective when placed on patient garments, specifically patient gowns. Since most patients receiving healthcare wear gowns and gowns can easily be seen from the patient's bedside, it is thought that the best placement would be on a garment or gown worn by a patient in various healthcare settings. Healthcare settings include hospitals where the gowns would be worn by non-ambulatory patients, and outpatient clinics where gowns would be worn by patients who are required to undress for a procedure and wear a gown for modesty. Therefore, a brief description of prior art will include examples of patient gowns. Many different gown designs exist, most of which are compatible with this invention.

Patient gowns may be made with many materials, including fabric, plastic, or other materials for single use or multiple use. Typically gowns are made with cotton and/or polyester and are designed for comfort, modesty, versatility, durability, and cost efficiency. While a basic design made from a single piece of cloth is often used, many variations exist including newer designs focusing more on patient comfort and fashion. Examples include the patent to Truitt et al., U.S. Pat. No. 5,133,086, which provides an update to gowns by providing a fully closeable seam that can open to provide access for medical care. The patent to Ragnone et al., 4,055,855, that offers multiple panels on the gown with an intravenous line holder in one sleeve, and the patent to Karmin, U.S. Pat. No. 5,367,710, that provides a gown with pants to improve patient privacy. Another recent improvement in gown design is described in the patent to Sharon, U.S. Pat. No. 0,157,358, with labels that identify a possible need for medical intervention and remind healthcare providers of a particular medical need of a patient. All of the aforementioned patents in addition to many others are compatible with the author's invention.

Due to the innumerable variety of gown, hospital linen, and healthcare provider attire designs, it is the opinion of the author that this invention may be best described by referencing prior art in existing U.S. patents. Examples include the patent to Truitt et al., U.S. Pat. No. 5,133,086, that provides an update to gowns by providing a fully closeable seam that can open to provide access for medical care; in FIG. 6 of the patent to Truitt, the prompts to promote hand hygiene compliance can be placed on the gown as indicated by 32, 33, and over the location of 34 (center chest). An additional example from the patent to Shamam, U.S. Pat. No. 6,484,321 includes a multipurpose patient gown in FIG. 1 of the patent to Shaman where text etc. can easily be placed across the center chest and sleeve cuffs of said design as well. Another recent improvement in gown design is described in the patent to Sharon, U.S. Pat. No. 0,157,358, with labels that identify a possible need for medical intervention and remind healthcare providers of a particular medical need of a patient. These labels could be replaced with said prompts with the specific goal of promoting hand hygiene compliance.

Placing visual prompts in the proximity of, and now, on the patients in any healthcare setting reminds those individuals in contact with the patient to wash their hands. It is a simple and cost effective means to promote compliance with CDC recommendations for hand hygiene and is an improvement upon cumbersome technologies described in patents that are not able to be conveniently implemented or have not shown to be effective. Prompts may be placed on any garments and linens in the proximity of the patient in the healthcare setting, although it is the belief of the inventors of this patent that placement on patient gowns is the best way to impact hand hygiene. Placement of visual prompts on patient gowns can be easily accomplished, are highly visible when close to the patient, and will provide a simple solution to the complex problem of poor hand hygiene compliance.

1: A patient gown to be used in the healthcare setting but not limited to use in hospitals, in outpatient clinics where patients may wear a gown during procedures, and in extended care facilities such as nursing homes. The said gown having
design for single use or repeat use,
been made of fabric, plastic, or any material used for patient gowns currently or in the future,
a body portion for providing patient modesty,
two sleeves for patient arms,
means for securing the gown around the patient,
any color or combination or colors in any pattern used in gown production for aesthetics or utility,
prompts for promoting hand hygiene among persons in contact of the said patient in the form of text, any language, symbols, objects, or other visual stimuli,
prompts that are visible at the bedside to a person visiting the said patient,
prompts that are readable by most with good vision at an arms length away from the patient,
prompts that may span across the chest of said patient's gown or the said sleeves,
one or multiple prompts in one or multiple locations on the patient's gown,
prompts including but not limited to text saying CLEAN YOUR HANDS, WASH YOUR HANDS, or PLEASE CLEAN YOUR HANDS FIRST or similar phrases in any language, prompts including but not limited to symbols that suggest hand washing such as two hands sprinkled with water from a faucet above,
prompts fixed on the garment with any means including but not limited to embroidery, buttons, stickers, paint, screen printing, transfer, or any other method.

2. Hospital linens including but not limited to sheets, blankets, pillowcases, or other linens used by the patient designed with the same intent of the gown in claim 1, intended to improve hand hygiene among persons in contact with the patient having,
any color or combination or colors in any pattern used in gown production for aesthetics or utility,
prompts for promoting hand hygiene among persons in contact of the said patient in the form of text, any language, symbols, objects, or other visual stimuli,
prompts that are visible at the bedside to a person visiting the patient,
prompts that are readable by most with good vision at an arms length away from the patient,
one or multiple prompts in one or multiple locations on the patients linens,
prompts including but not limited to text saying CLEAN YOUR HANDS, WASH YOUR HANDS, or PLEASE CLEAN YOUR HANDS FIRST or similar phrases,
prompts including but not limited to symbols that suggest hand washing such as two hands sprinkled with water from a faucet above
prompts fixed on the garment with any means including but not limited to embroidery, buttons, stickers, paint, screen printing, transfer, or any other method.

3. Hospital worker garments used as apparel in the healthcare setting such as surgical gowns, scrubs, scrub caps, and any other garment or linen used by those caring for the patient whose hand hygiene is essential in the prevention of microflora transmission having, any color or combination of colors in any pattern used in garment production for aesthetics or utility,
prompts for promoting hand hygiene among persons in contact with the patient in the form of text, any language, symbols, objects, or other visual stimuli,
prompts that are visible at the bedside to a patient or person visiting the said patient,
prompts that are readable by most with good vision at an arms length away from the patient,
prompts that may span the healthcare provider garment chest or the sleeves,
one or multiple said prompts in one or multiple locations on the healthcare workers garment,
prompts including but not limited to text saying CLEAN YOUR HANDS, WASH YOUR HANDS, or PLEASE CLEAN YOUR HANDS FIRST, ASK ME TO WASH MY HANDS, or similar phrases,
prompts including but not limited to symbols that suggest hand washing such as two hands sprinkled with water from a faucet above
prompts fixed on the garment with any means including but not limited to embroidery, buttons, stickers, paint, screen printing, transfer, or any other method.
